(19) United States
(12) Patent Application Publication
(10) Pub. No.: US 2016/0309485 A1
(43) Pub. Date: Oct. 20, 2016

(54) METHOD AND DEVICE FOR SUPPORTING COMMUNICATION OF ELECTRONIC DEVICE

(71) Applicant: Samsung Electronics Co., Ltd., Gyeonggi-do (KR)

(72) Inventors: Suha YOON, Seoul (KR); Eun-Seok Ryu, Seoul (KR); Euichang Jung, Seoul (KR); Suyoung Park, Gyeonggi-do (KR)

(73) Assignee: Samsung Electronics Co., Ltd.

(21) Appl. No.: 15/133,874

(22) Filed: Apr. 20, 2016

(30) Foreign Application Priority Data
Apr. 20, 2015 (KR) 10-2015-0055242

(51) Int. Cl. H04W 72/08; H04W 76/02

(52) U.S. Cl. CPC H04W 72/085; H04W 76/028

(57) ABSTRACT

An electronic device and a communication method are provided. The method for operating an electronic device includes initiating a hybrid service, measuring communication quality of a network to which an electronic device is connected, determining the quality of service (QoS) for data communication on the basis of the measured communication quality, transmitting information on the determined quality of the service, and receiving data transmitted through different communication paths corresponding to the QoS.

### PRIORITY

This application claims priority under 35 U.S.C. §119(a) to Korean Patent Application Serial No. 10-2015-0055242, which was filed in the Korean Intellectual Property Office on Apr. 20, 2015, the entire content of which is incorporated herein by reference.

### BACKGROUND

1. Field of the Disclosure

The present disclosure generally relates to a communication method which may effectively process data when the data is transferred through different communication paths in the electronic device capable of communicating through heterogeneous networks.

2. Description of the Related Art

In recent years, studies on a variety of technologies using wireless networks have been increasingly conducted. In particular, studies on a technology using a mobile communication network for a mobile communication service, a technology using a wireless local area network (WLAN) for a short-range wireless communication service, and a technology for linking heterogeneous networks have been increasingly conducted.

The WLAN has a disadvantage of providing a limited service area and low mobility with a relatively high service speed and low service cost. The mobile communication network has an advantage of supporting a large service area, high mobility and ensuring the quality of service (QoS) while having a slower service speed and higher cost. The mobile communication network may include a network for supporting a communication scheme such as a global system for mobile telecommunication (GSM), a universal mobile telecommunications system (UMTS), international mobile telecommunications-2000 (IMT-2000), code division multiple access (CDMA), wideband CDMA (WCDMA), long term evolution (LTE), and the like. The WLAN may include a network for supporting a communication scheme such as Wi-Fi, worldwide interoperability for microwave access (WiMAX), and the like.

Recently, a mobile convergence technology for combining various schemes of heterogeneous networks to interwork with each other has been developed. In addition, an electronic device (e.g., a multi-mode mobile terminal) which supports a multi-radio access technology (RAT) accessible to at least two communication schemes of heterogeneous networks has been developed.

A service which may simultaneously receive data through heterogeneous networks such as the WLAN and the mobile communication network have been provided. In addition, in data communication (e.g., video streaming, video call, video conference, etc.), the QoS should be guaranteed so that the user may use the data communication without inconvenience. Therefore, when separating data and providing the separated data through separated communication paths, as described above, the service quality of each of the communication paths should be guaranteed.

Thus, various studies have been conducted to ensure the QoS in the WLAN, however the studies are for ensuring the QoS between an electronic device and an Access Point (AP), and end-to-end QoS between electronic devices may not be guaranteed through such studies. In addition, as frequency resources are more efficiently managed, a mobile operator may provide better QoS and provide a communication service to a large number of users.

In heterogeneous network data communication, data is separated and the first separated data (e.g., video data) may be transmitted and received through a WLAN and second separated data (e.g., audio data) may be transmitted and received through a mobile communication network. In the WLAN, the QoS may not be guaranteed, and in the mobile communication network, radio resources may be inefficiently used while guaranteeing the QoS. For example, if the communication quality of the audio data is excessively guaranteed compared to the communication quality of the video data, it may lead to inefficient use of radio resources of the mobile communication network in the situation where the communication quality of the video data cannot be improved.

### SUMMARY

According to an aspect of the present disclosure, an electronic device supporting a hybrid service which more efficiently receives partitioned data transferred through heterogeneous networks and a communication method therefor are provided.

According to an aspect of the present disclosure, an electronic device which more efficiently processes data when the data is separated to be transferred through different communication paths and a communication method therefor are provided.

According to an aspect of the present disclosure, an electronic device which allows a communication resource to be more efficiently used when data is transferred through heterogeneous networks to improve the resource efficiency of the overall communication system and a communication method therefor are provided.

According to an aspect of the present disclosure, an electronic device which provides information associated with the QoS of heterogeneous networks, receives data through the heterogeneous networks, and supports data reception by the synchronization of the QoS of the heterogeneous networks and a communication method therefor are provided.

According to an aspect of the present disclosure, an electronic device and an operation method therefor, which provides an optimal environment for supporting data communication of the electronic device to improve the user's convenience and usability of the electronic device are provided.

In accordance with an aspect of the present disclosure, an electronic device includes a first communication module configured to perform communication with a first network, a second communication module configured to perform communication with a second network, and a controller functionally connected to the first communication module and the second communication module, wherein the controller is configured to measure a communication quality of a network in response to an initiation of a hybrid service, determine the QoS for data communication on the basis of the measured communication quality, and provide information on the determined quality of the service so as to process the reception of data transmitted through different communication paths corresponding to the QoS.

In accordance with another aspect of the present disclosure, a method for operating an electronic device includes initiating a hybrid service, measuring communication quality of a network to which an electronic device is connected, determining the QoS for data communication on the basis of the measured communication quality, transmitting information on the determined quality of the service, and receiving data transmitted through different communication paths corresponding to the QoS.

In accordance with an aspect of the present disclosure a non-transitory computer readable recording medium is provided which includes a program for executing operations, the operations include initiating a hybrid service, measuring the communication quality of a network to which an electronic device is connected, determining the QoS for data communication on the basis of the measured communication quality, transmitting information on the determined quality of the service, and receiving data transmitted through different communication paths corresponding to the QoS.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 illustrates an electronic device in a network environment that according to various embodiments of the present disclosure;

FIG. 2 is a block diagram of an electronic device according to various embodiments of the present disclosure;

FIG. 3 is a block diagram of a program module according to various embodiments of the present disclosure;

FIG. 4 is a block diagram schematically illustrating a configuration of an electronic device according to various embodiments of the present disclosure;

FIG. 5 is a flow diagram illustrating an operation of supporting data communication of an electronic device according to various embodiments of the present disclosure;

FIGS. 6 to 7 are diagrams illustrating operations of data communication of an electronic device according to various embodiments of the present disclosure;

FIG. 8 is a flowchart illustrating an operation of data communication in an electronic device according to various embodiments of the present disclosure;

FIG. 9 is a flowchart illustrating an operation of processing data reception in an electronic device according to various embodiments of the present disclosure;

FIG. 10 is a flowchart illustrating an operation of re-establishing network connection in an electronic device according to various embodiments of the present disclosure; and

FIG. 11 is a flowchart illustrating an operation of data transmission in an electronic device according to various embodiments of the present disclosure.

### DETAILED DESCRIPTION

Hereinafter, various embodiments of the present disclosure will be described with reference to the accompanying drawings. However, it should be understood that the present disclosure is not limited to the particular forms disclosed herein; rather, the present disclosure should be construed to cover various modifications, equivalents, and/or alternatives of embodiments of the present disclosure. In describing the drawings, similar reference numerals may be used to designate similar constituent elements.

The expressions “a first”, “a second”, “the first”, or “the second” used in various embodiments of the present disclosure may modify various components regardless of the order and/or the importance, but do not limit the corresponding components. For example, a first user device and a second user device indicate different user devices, although both of them are user devices. For example, a first element may be referred to as a second element, and similarly, a second element may be referred to as a first element without departing from the scope of the present disclosure.

An electronic device according to various embodiments of the present disclosure may include at least one of, for example, a smart phone, a tablet personal computer (PC), a mobile phone, a video phone, an electronic book reader (e-book reader), a desktop PC, a laptop PC, a netbook computer, a workstation, a server, a personal digital assistant (PDA), a portable multimedia player (PMP), an MPEG-1 audio layer-3 (MP3) player, a mobile medical device, a camera, and a wearable device. The wearable device may include at least one of an accessory type (e.g., a watch, a ring, a bracelet, an anklet, a necklace, eye-glasses, a contact lens, or a head-mounted device (HMD)), a fabric or clothing integrated type (e.g., electronic clothing), a body-mounted type (e.g., a skin pad, or tattoo), and a bio-implantable type (e.g., an implantable circuit).

According to various embodiments of the present disclosure, the electronic device may be a home appliance. The home appliance may include at least one of, for example, a television, a digital video disk (DVD) player, a refrigerator, an air conditioner, a vacuum cleaner, a washing machine, a set-top box, a home automation control panel, a security control panel, a TV box (e.g., Samsung HomeSync™, Apple TV™, or Google TV™), a game console (e.g., Xbox™ and PlayStation™), a camcorder, and an electronic photo frame.

According to another embodiment of the present disclosure, the electronic device may include at least one of a navigation device, a global positioning system (GPS) receiver, an event data recorder (EDR), a flight data recorder (FDR), a vehicle infotainment devices, an electronic device for a ship (e.g., a navigation device for a ship), avionics, security devices, an automotive head unit, a robot for home or industry, an automatic teller machine (ATM), point of sales (POS) terminal, a projector, or an Internet of Things (IoT) device.

The electronic device according to various embodiments of the present disclosure may be a combination of one or more of the aforementioned devices. The electronic device may be a flexible device. Further, the electronic device is not limited to the aforementioned devices, and may include a new electronic device according to the development of new technologies.

Hereinafter, an electronic device according to various embodiments of the present disclosure will be described with reference to the accompanying drawings. As used herein, the term “user” may indicate a person who uses an electronic device or a device (e.g., an artificial intelligence electronic device) that uses an electronic device.

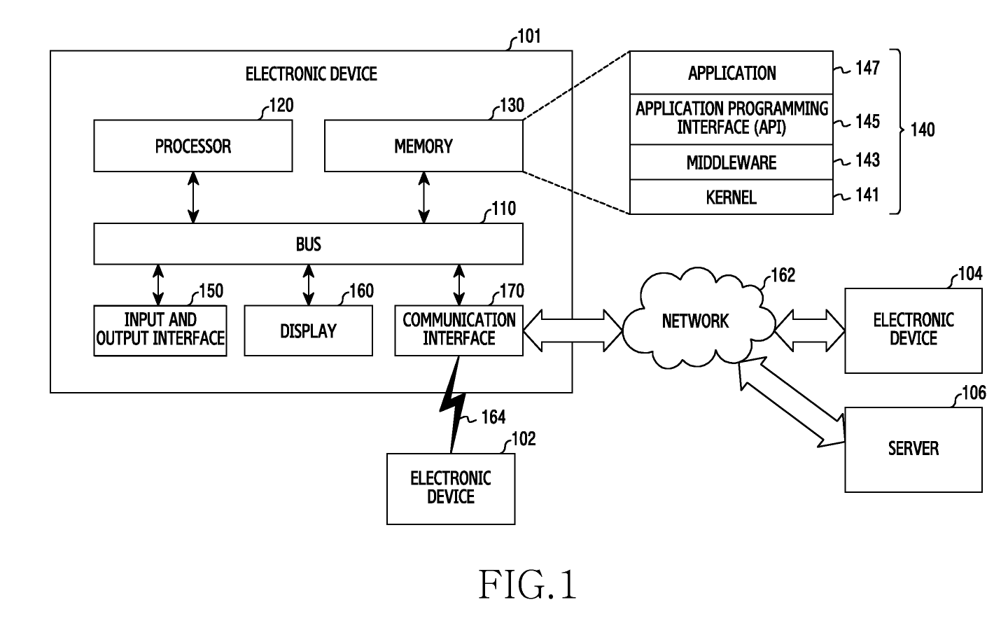

FIG. 1 illustrates an electronic device in a network environment according to various embodiments of the present disclosure.

An electronic device 101 within a network environment 100, according to various embodiments of the present disclosure, will be described with reference to FIG. 1. The electronic device 101 includes a bus 110, a processor 120, a memory 130, an input/output interface 150, a display 160, and a communication interface 170. The electronic device 101 may omit at least one of the above components or may further include other components.

The bus 110 may include, for example, a circuit which interconnects the components 110 to 170 and delivers communication and control messages and/or data between the components 110 to 170.

The processor 120 may include one or more of a central processing unit (CPU), an application processor (AP), and a communication processor (CP). The processor 120 may carry out, for example, calculation or data processing relating to control and/or communication of at least one other component of the electronic device 101.

The memory 130 may include a volatile memory and/or a non-volatile memory. The memory 130 may store, for example, commands or data relevant to at least one other component of the electronic device 101. According to an embodiment of the present disclosure, the memory 130 stores software and/or a program 140. The program 140 includes a kernel 141, middleware 143, an application programming interface (API) 145, and/or application programs (or “applications”) 147. At least some of the kernel 141, the middleware 143, and the API 145 may be referred to as an operating system (OS).

The kernel 141 may control or manage system resources (e.g., the bus 110, the processor 120, or the memory 130) used for performing an operation or function implemented in the other programs (e.g., the middleware 143, the API 145, or the application programs 147). Furthermore, the kernel 141 may provide an interface through which the middleware 143, the API 145, or the application programs 147 may access the individual components of the electronic device 101 to control or manage the system resources.

The middleware 143, for example, may serve as an intermediary for allowing the API 145 or the application programs 147 to communicate with the kernel 141 to exchange data.

The middleware 143 may process one or more task requests received from the application programs 147 according to assigned priorities. For example, the middleware 143 may assign priorities for using the system resources (e.g., the bus 110, the processor 120, the memory 130, and the like) of the electronic device 101, to at least one of the application programs 147. For example, the middleware 143 may perform scheduling or load balancing on the one or more task requests by processing the one or more task requests according to the assigned priorities.

The API 145 is an interface through which the applications 147 control functions provided from the kernel 141 or the middleware 143, and may include, for example, at least one interface or function (e.g., instruction) for file control, window control, image processing, character control, and the like.

The input/output interface 150, for example, may function as an interface that transfers commands or data input from a user or another external device to the other element(s) of the electronic device 101. Furthermore, the input/output interface 150 may output commands or data received from the other element(s) of the electronic device 101 to the user or another external device.

Examples of the display 160 may include a liquid crystal display (LCD), a light-emitting diode (LED) display, an organic light-emitting diode (OLED) display, a microelectromechanical systems (MEMS) display, and an electronic paper display. The display 160 may display, various types of content (e.g., text, images, videos, icons, or symbols) to users. The display 160 may include a touch screen, and may receive, a touch, gesture, proximity, or hovering input using an electronic pen or a user's body part.

The communication interface 170 may establish communication, for example, between the electronic device 101 and an external electronic device 102, 104, or a server 106. For example, the communication interface 170 may be connected to a network 162 through wireless or wired communication, and may communicate with an external device 104 or the server 106. The wireless communication may use at least one of, for example, long term evolution (LTE), LTE-advance (LTE-A), code division multiple access (CDMA), wideband CDMA (WCDMA), universal mobile telecommunications system (UMTS), wireless broadband (WiBro), and global system for mobile communications (GSM), as a cellular communication protocol. In addition, the wireless communication may include, for example, short range communication 164. The short-range communication 164 may include at least one of, for example, Wi-Fi, Bluetooth, near field communication (NFC), and global navigation satellite system (GNSS). GNSS may include, for example, at least one of global positioning system (GPS), global navigation satellite system (Glonass), Beidou navigation satellite system (Beidou) or Galileo (the European global satellite-based navigation system), based on a location, a bandwidth, and the like. Hereinafter, in the present disclosure, the term “GPS” may be interchangeably used with “GNSS”. The wired communication may include at least one of universal serial bus (USB), high definition multimedia interface (HDMI), recommended standard 232 (RS-232), and plain old telephone service (POTS). The network 162 may include at least one of a telecommunication network such as a computer network (e.g., a LAN or a WAN), the Internet, and a telephone network.

Each of the first and second external electronic devices 102 and 104 may be of a type identical to, or different from, that of the electronic device 101. According to an embodiment of the present disclosure, the server 106 may include a group of one or more servers. All or some of the operations performed in the electronic device 101 may be executed in another electronic device or a plurality of electronic devices 102, 104 or the server 106. When the electronic device 101 performs functions or services automatically or in response to a request, the electronic device 101 may request another electronic device 102, 104 or the server 106, to execute at least some functions relating thereto instead of, or in addition to, autonomously performing the functions or services. Another electronic device 102, 104, or the server 106 may execute the requested functions, or the additional functions, and may deliver a result of the execution to the electronic device 101. The electronic device 101 may process the received result as is, or process additionally, and may provide the requested functions or services. To this end, cloud computing, distributed computing, or client-server computing technologies may be used.

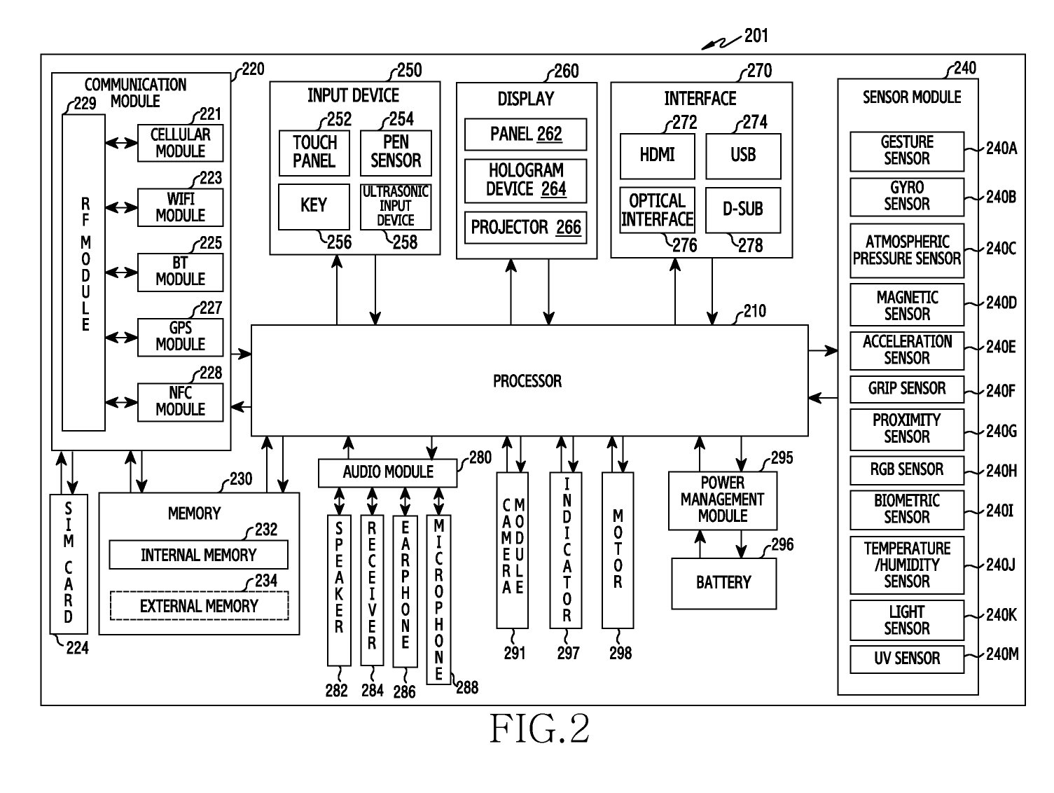

FIG. 2 is a block diagram of an electronic device according to various embodiments of the present disclosure. The electronic device 201 may include, the entire or a part of the electronic device 101 shown in FIG. 1. The electronic device 201 includes one or more processors 210 (e.g., application processors (AP)), a communication module 220, a subscriber identification module (SIM) 224, a memory 230, a sensor module 240, an input device 250, a display 260, an interface 270, an audio module 280, a camera module 291, a power management module 295, a battery 296, an indicator 297, and a motor 298.

The processor 210 may control a plurality of hardware or software components connected to the processor 210 by driving an operating system or an application program, and perform processing of data. The processor 210 may be embodied as, for example, a system on chip (SoC). The processor 210 may further include a graphic processing unit (GPU) and/or an image signal processor. The processor 210 may include at least some (for example, a cellular module 221) of the components illustrated in FIG. 2. The processor 210 may load, into a volatile memory, commands or data received from at least one of the other components (e.g., a non-volatile memory) and may process the loaded commands or data, and may store data in a non-volatile memory.

The communication module 220 may have a configuration the same as or similar to that of the communication interface 170 of FIG. 1. The communication module 220 includes a cellular module 221, a Wi-Fi module 223, a BT module 225, a GNSS module 227 (e.g., a GPS module, a Glonass module, a Beidou module, or a Galileo module), an NFC module 228, and a radio frequency (RF) module 229.

The cellular module 221, for example, may provide a voice call, a video call, or a text message service, or an Internet access service through a cellular communication network. According to an embodiment of the present disclosure, the cellular module 221 may identify and authenticate the electronic device 201 in a cellular communication network using the subscriber identification module 224 (for example, a SIM card). The cellular module 221 may perform at least some of the functions that the AP 210 may provide. The cellular module 221 may also include a communication processor (CP).

Each of the Wi-Fi module 223, the BT module 225, the GNSS module 227, and the NFC module 228 may include a processor for processing data transmitted/received through a corresponding module. At least some (e.g., two or more) of the cellular module 221, the Wi-Fi module 223, the BT module 225, the GNSS module 227, and the NFC module 228 may be included in one integrated chip (IC) or IC package.

The RF module 229, for example, may transmit/receive a communication signal (e.g., an RF signal). The RF module 229 may include a transceiver, a power amplifier module (PAM), a frequency filter, a low noise amplifier (LNA), and an antenna. At least one of the cellular module 221, the Wi-Fi module 223, the BT module 225, the GNSS module 227, and the NFC module 228 may transmit/receive an RF signal through a separate RF module.

The subscriber identification module card 224 may include an embedded SIM, and may contain unique identification information (e.g., an integrated circuit card identifier (ICCID)) or subscriber information (e.g., an international mobile subscriber identity (IMSI)).

The memory 230 (e.g., the memory 130) includes an embedded memory 232 and/or an external memory 234. The embedded memory 232 may include at least one of a volatile memory (e.g., a dynamic random access memory (DRAM), a static RAM (SRAM), a synchronous dynamic RAM (SDRAM), and the like) and a non-volatile memory (e.g., a one time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory), a hard disc drive, a Solid State Drive (SSD), and the like).

The external memory 234 may include a flash drive, for example, a compact flash (CF), a secure digital (SD), a micro secure digital (Micro-SD), a mini secure digital (Mini-SD), an extreme digital (xD), a multimedia card (MMC), a memory stick, and the like. The external memory 234 may be functionally and/or physically connected to the electronic device 201 through various interfaces.

The sensor module 240 may measure a physical quantity or detect an operation state of the electronic device 201, and may convert the measured or detected information into an electrical signal. The sensor module 240 includes at least one of a gesture sensor 240A, a gyro sensor 240B, an atmospheric pressure sensor (barometer) 240C, a magnetic sensor 240D, an acceleration sensor 240E, a grip sensor 240F, a proximity sensor 240G, an RGB sensor 240H (e.g., red, green, and blue), a biometric sensor (medical sensor) 2401, a temperature/humidity sensor 240J, an illuminance sensor 240K, and a ultra violet (UV) sensor 240M. Additionally or alternatively, the sensor module 240 may include an E-nose sensor, an electromyography (EMG) sensor, an electroencephalogram (EEG) sensor, an electrocardiogram (ECG) sensor, an infrared (IR) sensor, an iris scan sensor, and/or a finger print sensor.

The input device 250 includes a touch panel 252, a (digital) pen sensor 254, a key 256, or an ultrasonic input device 258. The touch panel 252 may use at least one of a capacitive type, a resistive type, an infrared type, and an ultrasonic type. The touch panel 252 may further include a tactile layer, and provide a tactile reaction to the user.

The (digital) pen sensor 254 may include a recognition sheet which is a part of the touch panel or is separated from the touch panel. The key 256 may include a physical button, an optical key or a keypad. The ultrasonic input device 258 may detect, through a microphone 288, ultrasonic waves generated by an input tool, and identify data corresponding to the detected ultrasonic waves.

The display 260 (e.g., the display 160) includes a panel 262, a hologram device 264, or a projector 266. The panel 262 may include a configuration identical or similar to the display 160 illustrated in FIG. 1. The panel 262 may be flexible, transparent, or wearable. The panel 262 may be embodied as a single module with the touch panel 252. The hologram device 264 may show a three dimensional (3D) image in the air using an interference of light method. The projector 266 may project light onto a screen to display an image. The screen may be located in the interior of, or on the exterior of, the electronic device 201.

The interface 270 includes a high-definition multimedia interface (HDMI) 272, a universal serial bus (USB) 274, an optical interface 276, or a D-subminiature (D-sub) 278. The interface 270 may be included in the communication interface 170 illustrated in FIG. 1. Additionally or alternatively, the interface 270 may include a mobile high-definition link (MHL) interface, a secure digital (SD) card/multi-media card (MMC) interface, or an infrared data association (IrDA) standard interface.

The audio module 280, may bidirectionally convert a sound and an electrical signal. At least some components of the audio module 280 may be included in the input/output interface 150 illustrated in FIG. 1. The audio module 280 may process voice input or output through a speaker 282, a receiver 284, earphones 286, or the microphone 288.

The camera module 291 is a device which may photograph a still image and a video image. According to an embodiment of the present disclosure, the camera module 291 may include one or more image sensors (e.g., a front sensor or a back sensor), a lens, an image signal processor (ISP) or a flash (e.g., LED or xenon lamp).

The power management module 295 may manage power of the electronic device 201. According to an embodiment of the present disclosure, the power management module 295 may include a power management integrated circuit (PMIC), a charger integrated circuit (IC), or a battery gauge. The PMIC may use a wired and/or wireless charging method. Examples of the wireless charging method may include, a magnetic resonance method, a magnetic induction method, an electromagnetic wave method, and the like. Additional circuits (e.g., a coil loop, a resonance circuit, a rectifier, etc.) for wireless charging may be further included. The battery gauge may measure a remaining charge of the battery 296, and a voltage, a current, or a temperature while charging. The battery 296 may include a rechargeable battery and/or a solar battery.

The indicator 297 may display a particular state (e.g., a booting state, a message state, a charging state, and the like) of the electronic device 201 or a part of the electronic device 201 (e.g., the processor 210). The motor 298 may convert an electrical signal into a mechanical vibration, and may generate a vibration, a haptic effect, and the like. The electronic device 201 may include a processing device (e.g., a GPU) for supporting a mobile TV. The processing device for supporting a mobile TV may process media data according to standards such as digital multimedia broadcasting (DMB), digital video broadcasting (DVB), or MediaFLO™.

Each of the above-described component elements of hardware may be configured with one or more components, and the names of the corresponding component elements may vary based on the type of electronic device. In various embodiments of the present disclosure, the electronic device may include at least one of the above-described elements. Some of the above-described elements may be omitted from the electronic device, or the electronic device may further include additional elements.

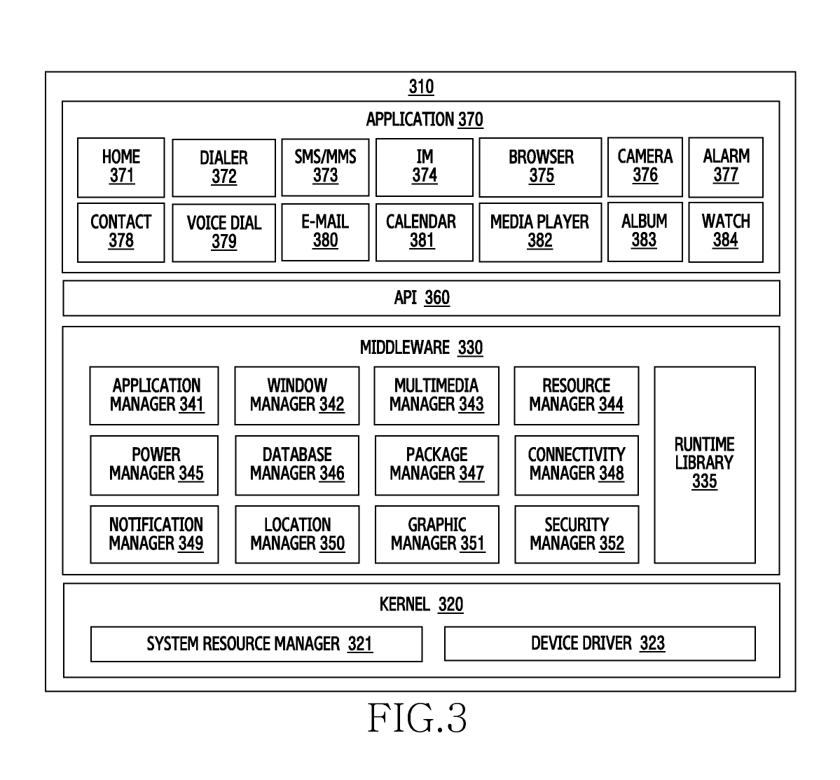

FIG. 3 is a block diagram of a program module according to various embodiments of the present disclosure.

According to an embodiment of the present disclosure, the program module 310 (e.g., the program 140) may include an operating system (OS) for controlling resources related to the electronic device (e.g., the electronic device 101) and/or various applications (e.g., the application programs 147) executed in the operating system. The operating system may be Android™, iOS™, Windows™, Symbian™, Tizen™, Bada™, and the like.

The program module 310 includes a kernel 320, middleware 330, an API 360, and/or applications 370. At least some of the program module 310 may be preloaded on an electronic device, or may be downloaded from an external electronic device 102, 104, or the server 106.

The kernel 320 (e.g., the kernel 141) includes a system resource manager 321 and/or a device driver 323. The system resource manager 321 may control, allocate, or collect system resources. The device driver 323 may include a display driver, a camera driver, a Bluetooth driver, a shared memory driver, a USB driver, a keypad driver, a Wi-Fi driver, an audio driver, or an inter-process communication (IPC) driver.

The middleware 330 may provide a function required by the applications 370, or may provide various functions to the applications 370 through the API 360 to enable the applications 370 to efficiently use the limited system resources in the electronic device 101. According to an embodiment of the present disclosure, the middleware 330 (e.g., the middleware 143) includes at least one of a run time library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module that a compiler uses in order to add a new function through a programming language while an application 370 is being executed. The runtime library 335 may perform input/output management, memory management, an arithmetic function, and the like.

The application manager 341 may manage a life cycle of at least one of the applications 370. The window manager 342 may manage graphical user interface (GUI) resources used by a screen. The multimedia manager 343 may recognize a format required for reproduction of various media files, and may perform encoding or decoding of a media file by using a codec suitable for the corresponding format. The resource manager 344 may manage resources of a source code, a memory, and a storage space of at least one of the applications 370.

The power manager 345 may operate together with a basic input/output system (BIOS) and the like, to manage a battery or power source and may provide power information required for the operation of the electronic device. The database manager 346 may generate, search for, and/or change a database to be used by at least one of the applications 370. The package manager 347 may manage installation or an update of an application distributed in the form of a package file.

For example, the connectivity manager 348 may manage wireless connectivity such as Wi-Fi or Bluetooth. The notification manager 349 may display or notify of an event such as an arrival message, proximity notification, and the like in such a way that does not disturb a user. The location manager 350 may manage location information of an electronic device. The graphic manager 351 may manage a graphic effect which will be provided to a user, or a user interface related to the graphic effect. The security manager 352 may provide all security functions required for system security, user authentication, and the like. According to an embodiment of the present disclosure, when the electronic device 101 has a voice or video call function, the middleware 330 may further include a telephony manager for managing a voice call function or a video call function of the electronic device.

The middleware 330 may provide a module specialized for each type of OS in order to provide a differentiated function. Further, the middleware 330 may dynamically remove some of the existing components or add new components.

The API 360 (e.g., the API 145) is, for example, a set of API programming functions, and may be provided with a different configuration according to an OS. For example, in the case of Android™ or iOS™, one API set may be provided for each platform. In the case of Tizen™, two or more API sets may be provided for each platform.

The applications 370 includes one or more applications which may provide functions such as home 371, dialer 372, SMS/MMS 373, instant message (IM) 374, browser 375, camera 376, alarm 377, contacts 378, voice dial 379, email 380, calendar 381; media player 382, album 383, clock 384, health care (e.g., measuring exercise quantity or blood sugar levels), or environment information (e.g., providing atmospheric pressure, humidity, or temperature information).

According to an embodiment of the present disclosure, the applications 370 may include an information exchange application that supports exchanging information (e.g., notification information) between the electronic device 101 and an external electronic device 102, 104 or the server 106. The notification relay application may receive notification information from, for example, an external electronic device and provide the received notification information to a user.

According to various embodiments of the present disclosure, at least a part of the programming module 310 may be implemented in software, firmware, hardware, or a combination of two or more thereof. At least some of the program module 310 may be implemented (e.g., executed) by the processor 1410.

The term “module” as used herein may refer to a unit including one of hardware, software, and firmware or a combination of two or more. The term “module” may be interchangeably used with, for example, the terms “unit”, “logic”, “logical block”, “component”, or “circuit”. The “module” may be a minimum unit for performing one or more functions or a part thereof. The “module” may include at least one of an application-specific integrated circuit (ASIC) chip, a field-programmable gate arrays (FPGA), and a programmable-logic device for performing operations which is currently known or to be developed hereinafter.

According to various embodiments of the present disclosure, at least some of the devices (for example, modules or functions thereof) or the method (for example, operations) may be implemented by commands or instructions stored in a computer-readable storage medium in a programming module form. The commands or instructions, when executed by a processor (e.g., the processor 120), may cause the one or more processors to execute the function corresponding to the commands or instructions. The computer-readable recoding media may be, for example, the memory 130.

The computer readable recoding medium may include a hard disk, a floppy disk, magnetic media (e.g., a magnetic tape), optical media (e.g., a compact disc read only memory (CD-ROM) and a digital versatile disc (DVD)), magneto-optical media (e.g., a floptical disk), a hardware device (e.g., a read only memory (ROM), a random access memory (RAM), a flash memory), and the like.

Any of the modules or programming modules may include at least one of the above described elements, exclude some of the elements, or further include additional elements. The operations performed by the modules, programming module, or other elements according to various embodiments of the present disclosure may be executed in a sequential, parallel, repetitive, or heuristic manner. Further, some operations may be executed according to another order, or may be omitted, or other operations may be added.

Various embodiments disclosed herein are provided to describe technical details of the present disclosure and to help the understanding of the present disclosure, and do not limit the scope of the present disclosure. Therefore, it should be construed that all modifications and changes, or modified and changed forms based on the technical idea of the present disclosure fall within the scope of the present disclosure.

Various embodiments of the present disclosure relate to an electronic device including a communication function and an operation method therefor. Various embodiments of the present disclosure include an electronic device which may receive data (e.g., large amounts of media data, streaming-based media data, data according to a video conference or a video call, etc.) by simultaneously using heterogeneous networks.

According to various embodiments of the present disclosure, an electronic device (e.g., a first electronic device) receiving data may measure the QoS for heterogeneous networks in the hybrid service-based data communication system and provide a result of the QoS measurement. When transmitting data in response to a data transmission request by the first electronic device, an electronic device (e.g., a second electronic device or a server) transmitting data may transfer the data to the first electronic device through heterogeneous networks based on the QoS measurement result provided by the first electronic device.

When transmitting the data, the second electronic device may partition the data to correspond to communication paths corresponding to heterogeneous networks, and transfer the partitioned data (e.g., the first partitioned data and the second partitioned data) to the heterogeneous networks through the communication paths. When transmitting any partitioned data by the second electronic device to the first electronic device, at least one network among the heterogeneous networks may transmit the partitioned data to the first electronic device based on the QoS (e.g., communication speed, latency or other QoS metric(s)) which corresponds to QoS measurement results provided by the first electronic device.

According to various embodiments of the present disclosure, when the data is partitioned and transferred to different communication paths corresponding to heterogeneous networks, the data may be transferred by considering (e.g., synchronizing) the service quality of the heterogeneous networks, and the data transfer may be more efficiently processed. In a robust communication environment of heterogeneous networks (e.g., a communication environment where communication speeds equal to or higher than a predetermined level may be achieved), the present disclosure may support higher data transfer, and in a poor communication environment of heterogeneous networks (e.g., a communication environment where a communication speed less than a predetermined level may be achieved), the present disclosure may support data transfer higher than a predetermined level of speed. When data is transmitted through heterogeneous networks, the data may be received through at least two communication paths and the data communication may be at a higher speed than using one communication path. In addition, the data may be provided by allocating resources to correspond to the QoS through the synchronization of the QoS for the heterogeneous networks, and system resources may be managed and conserved, thereby enabling provision of services to other electronic devices. Therefore, when transmitting data by heterogeneous networks, the present disclosure allows a more efficient use of the communication resources to increase the resource efficiency of the overall communication system.

In the following description, the term “hybrid service” may refer to a mode, function, or service of simultaneously connecting an electronic device to heterogeneous networks supporting different communication schemes to receive data through different communication paths corresponding to the heterogeneous networks.

In various embodiments of the present disclosure, the heterogeneous networks include a first network and a second network supporting different communication schemes of the electronic device. The first network may include a wireless local area network (WLAN) for a short-range communication service of the electronic device, and the second network may include a mobile communication network (or a cellular network) for a mobile communication service.

The mobile communication network (or a cellular network) may include LTE, LTE-A, GSM, UMTS, international mobile telecommunications-2000 (IMT-2000), CDMA, WCDMA, etc. The WLAN may include Wi-Fi, WiBro, worldwide interoperability for microwave access (WiMAX), and the like.

The electronic device may include a plurality of communication modules (e.g., the mobile communication module and the WLAN module) capable of communicating (connecting) with heterogeneous networks (e.g., the mobile communication network and the WLAN).

Hereinafter, a method, apparatus, and system for performing data communication based on a hybrid service. However, the embodiments of the present disclosure are not limited to the descriptions provided below.

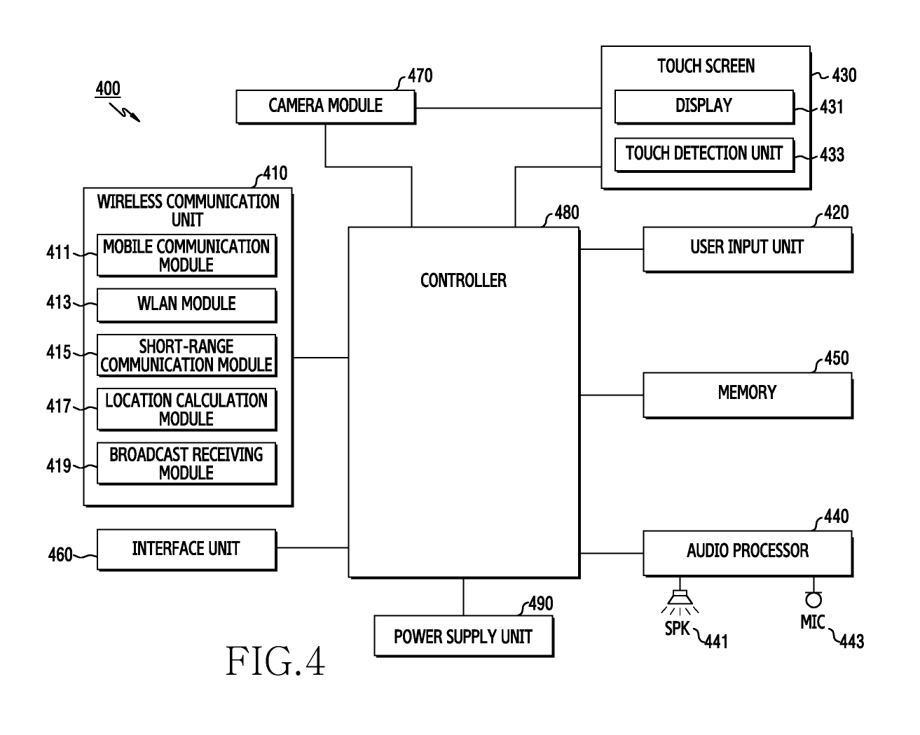

FIG. 4 is a diagram schematically illustrating a configuration of an electronic device according to various embodiments of the present disclosure.

Referring to FIG. 4, an electronic device 400 includes a wireless communication unit 410, a user input unit 420, a touch screen 430, an audio processor 440, a memory 450, an interface unit 460, a camera module 470, a controller 480, and a power supply unit 490. The electronic device 400 may include fewer or more component elements when compared to the component elements of FIG. 4.

The wireless communication unit 410 may include a configuration identical or similar to the communication module 220 of FIG. 2. The wireless communication unit 410 may include one or more modules which enable wireless communication between the electronic device 400 and a wireless communication system or between the electronic device 400 and another electronic device 102, 104, or a server 106. The wireless communication unit 410 includes a mobile communication module 411, a wireless LAN module 413, a short-range communication module 415, a location calculation module 417, and a broadcast receiving module 419. The wireless communication unit 410 may perform wireless communication with heterogeneous networks (e.g., a mobile communication network and wireless LAN) based on the configured communication scheme.

The mobile communication module 411 may transmit and receive a wireless signal to and from at least one of a base station, an external electronic device 104, and various servers (e.g., an integration server, a provider server, a content server, an internet server, a cloud server, and the like), over a mobile communication network. The wireless signal may include a voice call signal, a video call signal, and text/multimedia messages.

The mobile communication module 411 may receive data (e.g., content, a message, email, an image, a video, weather information, location information, time information, and the like). The mobile communication module 411 may receive various data by being connected with at least one other electronic devices 102, 104 or the server 106, which are connected with the electronic device 400 over a network (e.g., the mobile communication network). The mobile communication module 411 may transmit data required for the operations of the electronic device 400 to the external device 104 or the server 106, in response to a user's request.

The mobile communication module 411 may perform a communication function. For example, the mobile communication unit 411 may convert, under a control of the controller 480, a radio frequency (RF) signal into a baseband signal and then provide the converted signal to the controller 480, or convert the baseband signal from the controller 480 into the RF signal and then transmit the RF signal. Here, the controller 480 may process the baseband signal based on various communication schemes. For example, the communication schemes may include LTE, LTE-A, GSM, UMTS, IMT-2000, CDMA, or WCDMA, but is not limited thereto.

The WLAN module 413 may include a module for establishing a wireless Internet access and a wireless LAN link with another electronic device 102 or the server 106. The WLAN module 413 may be installed inside or outside the electronic device 400. The wireless Internet technology including Wi-Fi, WiBro, WiMax, high speed downlink packet access (HSDPA), millimeter wave (mmWave), and the like may be utilized.

The WLAN module 413 may transmit data selected by the user to the outside or receive the data from the outside. The WLAN module 413 may be linked to another electronic device directly or the server that is connected to the electronic device 400 via a network (e.g., a wireless LAN) to transmit data of the electronic device 400 to the outside, or receive data from the outside. The WLAN module 413 may always remain in a turned-on state or may be turned on according to a setting of the electronic device 400 or a user input.

The short-range communication module 415 may be a module for performing short-range communication. The short-range communication technologies include Bluetooth, Bluetooth Low Energy (BLE), radio frequency identification (RFID), infrared data association (IrDA) communication, ultra wideband (UWB), ZigBee, near field communication (NFC), etc.

The short-range communication module 415 may receive data. The short-range communication module 415 may be linked to another electronic device that is connected to the electronic device 400 via a network (e.g., a personal network, a short-range communication network), and transmits or receives data of the electronic device 400 to or from the other electronic device. The short-range communication module 415 may always remain in a turned-on state or may be turned on according to a setting of the electronic device 400 or a user input.

The location calculation module 417 is a module for acquiring a location of the electronic device 400, and may include a global position system (GPS) module. The location calculation module 417 may measure the position of the electronic device 400 based on the principle of triangulation. For example, the location calculation module 417 may calculate three dimensional information on a current location according to a latitude, a longitude, and an altitude, by calculating information on the distance from three or more base stations and time information, and then applying trigonometry to the calculated information. Alternatively, the location calculation module 417 may calculate location information by continuously receiving location information on the electronic device 400 from three or more satellites in real time. The position information of the electronic device 400 may be obtained by various methods.

The broadcast reception module 419 may receive a broadcast signal (e.g., a TV broadcast signal, a radio broadcast signal, a data broadcast signal, and the like) and/or broadcast related information (e.g., information associated with a broadcast channel, a broadcast program, or a broadcast service provider) from an external broadcast management server through a broadcast channel (e.g., a satellite broadcast channel, a terrestrial broadcast channel, and the like).

The user input unit 420 may generate input data for controlling the operation of the electronic device 400 in response to a user input. The user input unit 420 may include at least one input device for detecting various user inputs. For example, the user input unit 420 may include a keypad, a dome switch, a physical button, a touch pad (resistive type/capacitive type), a jog & shuttle, a sensor (e.g., a sensor module 240), etc.

The user input unit 420 may be buttons located outside the electronic device 400 or some or all of the user input unit 420 may be a touch panel. The user input unit 420 may receive a user input for initiating the operation of the electronic device 400 and generate an input signal according to the user input. For example, the user input unit 420 may receive inputs for performing a network connection, data transmission or reception by the hybrid service, application execution, data input (write, insert), a change in position of the electronic device 400, content indication, etc., and generate an input signal according to the user input.

The touch screen 430 may indicate an input/output means that simultaneously performs an input function and a display function, and may include a display 431 (e.g., the display 160 or 260), and a touch detecting unit 433. The touch screen 430 may provide an input/output interface between the electronic device 400 and the user, may transfer a touch input of the user to the electronic device 400, and may show an output from the electronic device 400 to the user. The touch screen 430 may show a visual output to the user. The visual output may be text, graphic, video, or a combination thereof. For example, the touch screen 430 may display various screens including a messenger screen, a call screen, a game screen, a video playback screen, a gallery screen, a web page screen, a home screen, a network connection screen, or a data reception screen, etc.

The touch screen 430 may detect an event (e.g., a touch event, a hovering event, or an air gesture event) based on at least one of a touch, hovering, and air gesture from the user through the touch detection unit 433 while a particular screen is displayed through the display 431, and transmit an input signal according to the event to the controller 480. The controller 480 may distinguish the event and control an operation according to the event.

The display 431 may display (output) various information processed in the electronic device 400. For example, the display 431 may display a user interface (UI) or a graphic user interface (GUI) related to a call when the electronic device 400 operates in a call mode. When the electronic device 400 is in a video call mode or a photography mode, the display 431 may display a photographed and/or received image and a UI or a GUI, related to the operation of the corresponding mode. When the electronic device 400 operates in a hybrid mode, the display 431 may display a UI or a GUI, related to the reception of data through heterogeneous networks. The display 431 may display data or content related to the use of the electronic device 400 or information on other electronic devices connected to the network. The display 431 may display various screens corresponding to executed applications.

The display 431 may support a screen display in a landscape mode according to a rotation direction (or an orientation) of the electronic device 400, a screen display according a portrait mode, and a screen display according to a change between the landscape mode and the portrait mode. The display 431 may use various displays. Some of the displays may be implemented as a transparent display in a transparent or photo-transparent type.

The touch detection unit 433 may be located on the display 431 and may detect a user input which contacts or approaches the surface of the touch screen 430. The user input may include a touch event or a proximity event based on at least one of a single-touch, a multi-touch, a hovering, or an air gesture. The user input may be a tap, drag, sweep, flick, drag&drop, drawing gesture (e.g., writing), and the like. The touch detection unit 433 may detect a user input (e.g., a touch event or a proximity event) on the surface of the touch screen 430, generate a signal corresponding to the detected user input, and transfer the generated signal to the controller 480. The controller 480 may control execution of a function corresponding to an area where the user input (e.g., the touch event or the proximity event) is generated by the signal transferred from the touch detection unit 433.

The touch detecting unit 433 may receive a user input for initiating an operation related to the use of the electronic device 400 or may generate an input signal based on a user input. The touch detection unit 433 may convert a change in pressure applied to a specific portion of the display 431 or a change in electrostatic capacitance generated at a specific area of the display 431 into an electric input signal. The touch detection unit 433 may detect a location and an area of the surface of the display 431 which an input means (e.g., a user's finger, an electronic pen, and the like) touches or approaches. The touch detection unit 433 may also detect pressure when the touch is made according to the applied touch type. When there is a touch or proximity input on the touch detection unit 433, a signal(s) corresponding to the touch or proximity input may be transferred to a touch screen controller. The touch screen controller may process the signal(s), and then transmit corresponding data to the controller 480. Accordingly, the controller 480 may identify which area of the touch screen 430 is touched or approached, and process execution of a function corresponding to the touch or proximity.

The audio processing unit 440 may include a configuration identical or similar to the audio module 280 of FIG. 2. The audio processor 440 may transmit, to a speaker (SPK) 441, an audio signal input from the controller 480, and may transfer an audio signal such as a voice input from a microphone (MIC) 443 to the controller 480. The audio processing unit 440 may convert voice/sound data into audible sound through the speaker 441 based on the control of the controller 480 and may output the audible sound, and may convert an audio signal such as a voice and the like, which is received from the microphone 443 into a digital signal and may transfer the digital signal to the controller 480. The audio processor 440 may output an audio signal corresponding to a user input according to audio processing information (e.g., an effect sound, a music file, and the like) inserted into data.

The speaker 441 may output audio data received from the wireless communication unit 410 or stored in the memory 450. The speaker 441 may output sound signals related to various operations (functions) performed by the electronic device 400. The speaker 441 may output an audio stream such as voice recognition, voice copy, digital recording, and a phone call function. The speaker 441 may include an attachable and detachable earphone, headphone, or headset, and the earphone, headphone, or headset may be connected to the electronic device 400 through an external port.

The microphone 443 may receive an external sound signal and process the received sound signal as electric voice data. When the electronic device 400 is in a call mode, the voice data processed through the microphone 443 may be converted into a form capable of being transmitted through the mobile communication module 411. Various noise reduction algorithms may be implemented in the microphone 443 to remove noise generated during the process of receiving an external sound signal. The microphone 443 may serve to input an audio stream such as a voice command (e.g., a voice command for initiating a data reception operation based on a hybrid service), voice recognition, digital recording, and a phone call function. For example, the microphone 443 may convert a voice signal into an electric signal. The microphone 443 may include an internal microphone, mounted in the electronic device 400 and an external microphone connected to the electronic device 400.

The memory 450 (e.g., the memory 130 and 230) may store one or more programs that are executed by the controller 480, and may perform a function for temporarily storing input/output data. The input/output data may include, for example, various identification information (information such as temporary mobile subscriber identity (TMSI), packet-TMSI (P-TMSI), international mobile subscriber identity (IMSI) (e.g., mobile country code (MCC), mobile network code (MNC)), international mobile station equipment identity (IMEI), channel information (E.G., paging channel information), content, messenger data (e.g., text or conversation data), contact information (e.g., wired or wireless phone number, etc.), a message, media data (e.g., files such as audio, video, images, etc.), and the like.

The memory 450 may store one or more programs and data related to a control function for the data communication of the electronic device 400. For example, the memory 450 may store one or more programs for executing operations including connecting to heterogeneous networks, measuring the QoS of the connected heterogeneous networks, determining the QoS for data communication performed by the heterogeneous networks based on a result of measurement, generating service information based on the result of determination, transmitting the generated service information to the outside (e.g., a mobile communication network, a server), receiving data (e.g., partitioned data) transmitted through respective communication paths based on the service information from the heterogeneous networks, and outputting the received data to the user.

The memory 450 may store the frequency of use according to the electronic device 400 (e.g., the frequency of the network connection, the frequency of use of the applications, the frequency of use of the content, etc.), importance, and priority. The memory 450 may store data related to various patterns of vibration and sound output in response to a touch input or a proximity input on the touch screen 430. The memory 450 may permanently or temporarily store an operating system (OS) of the electronic device 400, a program related to an input and display control using the touch screen 430, a program related to control of various operations (functions) of the electronic device 400, and various data generated by the operations of the programs. The memory 450 includes an external memory 234 and an internal memory 232. The electronic device 400 may also perform a storage function of the memory 450 on the Internet.

The memory 450 may store various software. For example, software components may include an operating system software module, a communication software module, a graphic software module, a user interface software module, a moving picture experts group (MPEG) module, a camera software module, and one or more application software modules.

The operating system software module may include various software components for controlling general system operation which may refer to memory management and control, and storage hardware (device) control and management, and power control and management. The operating system software module may execute communication between various hardware (devices) and the software component (module).

The communication software module may allow the electronic device to communicate with another electronic device such as a wearable device, a network, a computer, a server, or a portable terminal through the wireless communication unit 410. The communication software module may be configured with a protocol corresponding to the communication scheme.

The graphic software module may include various software components for providing and displaying graphics on the touch screen 430. The term “graphics” may refer to text, web page, icon, digital image, video, and animation.

The user interface software module may include various software components related to a user interface (UI). The user interface software module may include content relating to how the status of the user interface is changed or under what conditions the status of the user interface is changed.

The MPEG module may include a software component which enables a digital content (e.g., video and audio data) related process and function (e.g., generation, reproduction, distribution, and transmission of content).

The camera software module may include a camera-related software component which enables a camera-related process and function.

The application module includes a web browser including a rendering engine, email, instant message, word processing, keyboard emulation, address book, touch list, widget, digital right management (DRM), voice recognition, position determining function, location based service, and the like. In transferring data (e.g., media data, streaming media data, video conference or video call data, etc.) by simultaneously using heterogeneous networks, the application module may synchronize the QoS for heterogeneous networks.

The interface unit 460 may include a configuration identical or similar to the interface 270 of FIG. 2. The interface unit 460 may serve as an interface between the electronic device 400 and all external devices connected to the electronic device 400. The interface unit 460 may receive data from an external device, receive power and transfer the data and power to respective components within the electronic device 400, or allow data within the electronic device 400 to be transmitted to the external device. The interface unit 460 may include a wired/wireless headset port, an external charger port, a wired/wireless data port, a memory card port, a port for connecting a device provided with an identification module, an audio input/output port, a video input/output port, an earphone port, and the like.

The camera module 470 may include a configuration that supports a photographing function of the electronic device 400. The camera module 470 may support capturing an image (a still image or a dynamic image) of a subject. The camera module 470 may photograph a subject and transfer photographed data to the display 431 and the controller 480. The camera module 470 may include an image sensor (or a camera sensor) for converting an input photo signal into an electric signal and an image signal processing unit for converting the electric signal input from the image sensor into a digital video data. The image sensor may include a charge-coupled device (CCD) or a complementary metal-oxide-semiconductor (CMOS).

The controller 480 may control general operation of the electronic device 400. For example, the controller 480 may perform a control related to voice communication, data communication, video communication, and the like. The controller 480 may include one or more processors or the controller 480 may be referred to as a processor. For example, the controller 480 may include a communication processor (CP), an application processor (AP), an interface (e.g., general purpose input/output (GPIO)), or an internal memory as separate component elements, or integrate them into one or more integrated circuits. The application processor may execute various software programs to perform various functions for the electronic device 400, and the communication processor may process and control voice communication and data communication.

The controller 480 may control operations associated with the performance of the data communication function based on the hybrid service of the electronic device 400. The controller 480 may measure the communication QoS of the network (e.g., the first network and the second network) in response to an initiation of the hybrid service of the electronic device 400.

The controller 480 may determine the QoS for data communication on the basis of the measured communication quality and provide information on the QoS. For example, the controller 480 may transmit information on the QoS to an external device (e.g., server, other electronic devices, etc.) for providing data, and transmit information on the QoS to a particular network (e.g., a mobile communication network) to which the electronic device 400 is connected.

The controller 480 may receive data transmitted through different communication paths according to communication QoS provided by the electronic device 400 in processing an operation (e.g., streaming services, storing, etc.).

The controller 480 may interwork with the software module stored in the memory 450 to perform data communication operation of the electronic device 400. The controller 480 may be implemented by one or more modules.

The controller 480 may be implemented by one or more processors that control the operation of the electronic device 400 by executing one or more programs stored in the memory 450. The controller 480 may include a data management module for processing the data transmission and reception, a quality measurement module for measuring communication quality for one or more networks connected to the electronic device 400, and a quality determination module for determining a QoS for adjusting the communication quality required for the data communication with the mobile communication network. The communication quality measurement may be performed for only one network (e.g., WLAN) to which the electronic device 400 is connected, or both networks (e.g., a wireless LAN and a mobile communication network).

The controller 480 may control various operations associated with the electronic device 400 as well as the above described functions. When a particular application is executed, the controller 480 may control an operation and a screen display of the particular application. Further, the controller 480 may receive input signals corresponding to various touch event or proximity event inputs supported by a touch-based or proximity-based input interface (e.g., the touch screen 430) and may control functions according to the received input signals. Moreover, the controller 480 may also control data transmission/reception based on wired communication or wireless communication.

The power supply unit 490 may receive external power and internal power and may supply the power required for an operation under the control of the controller 480. The power supply unit 490 may provide or block power (on/off) to one or more processors of the controller 480, a display 431, and a wireless communication unit 410 under the control of the controller 480.

Various embodiments of the present disclosure may be implemented in a non-transitory computer (or similar device)-readable recording medium using software, hardware or a combination thereof. The embodiments of the present disclosure may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, micro-processors, and electrical units for performing other functions.

A non-transitory computer readable recording medium in which a program for executing operations is recorded is provided, the operations include initiating a hybrid service, measuring communication quality of a network to which an electronic device is connected, determining service quality for data communication on the basis of the measured communication quality, transmitting information on the determined service quality, and receiving data transmitted through different communication paths to correspond to the service quality.

The embodiments of the present disclosure may be implemented by the controller 480. The procedures and functions described in the present disclosure may also be implemented as separate software modules. The software modules may perform one or more functions and operations described in the present disclosure.

At least a part of functions performed by the electronics device 400 may be performed by an external device (e.g., the server 106). For example, the server 106 may include a processing module corresponding to the controller 480, and process at least a part of the function related to supporting the hybrid service-based data communication of the electronic device 400 based on at least a part of the information transmitted from the electronic device 400 by using the processing module, and transmit a result thereof to the electronic device 400.

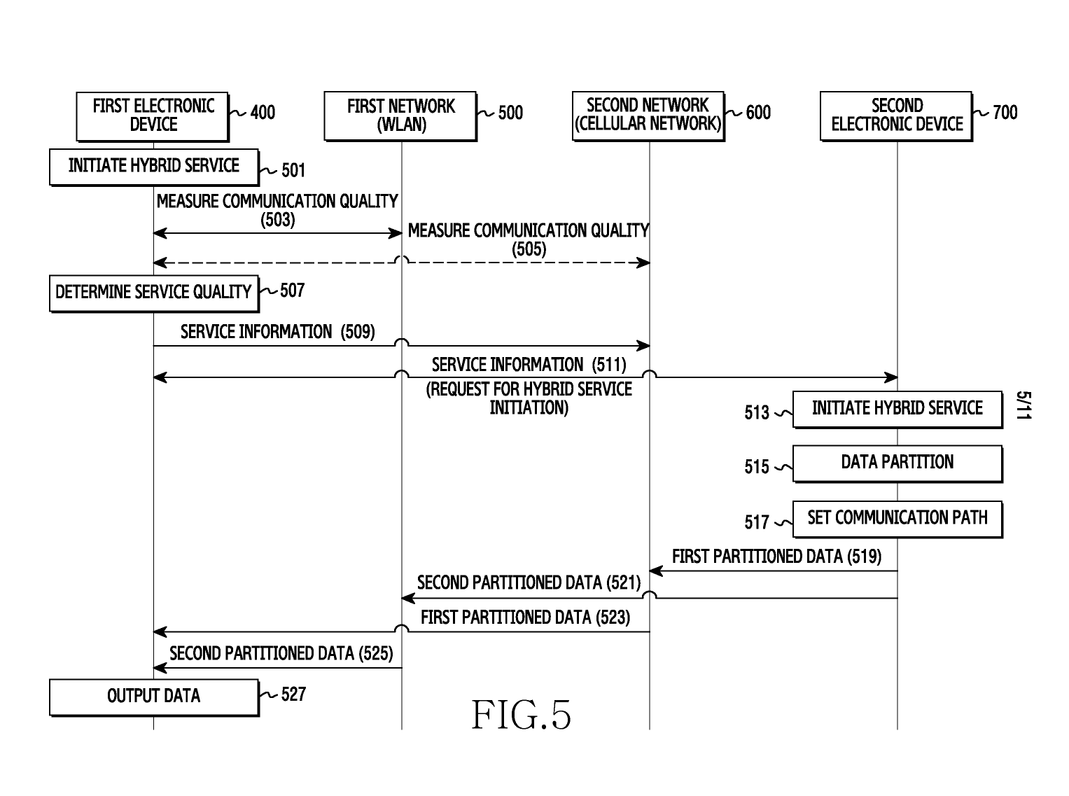

FIG. 5 is a flow diagram illustrating an operation of supporting data communication of an electronic device according to various embodiments of the present disclosure.

Referring to FIG. 5, in step 501, the first electronic device 400 initiates a hybrid service. A user may execute an application through a user interface (UI) of the first electronic device 400. The application may include a video call application, a video conference application, a streaming application, etc. The application may perform data communication with a remote electronic device (e.g., a second electronic device 700). The video call application may perform communication with a communication partner of the second electronic device 700, the video call application may perform data communication between conference participants of the second electronic device 700, and the streaming service application may perform communication with a server, the second electronic device 700 that provides video content. The first electronic device 400 may initiate the hybrid service in response to the user's application. A hybrid communication application for data communication may be separately provided, and the hybrid service may be initiated by selecting and executing the hybrid communication application. The hybrid service may be automatically initiated when the user of the first electronic device 400 detects a request for data equal to or greater than a particular data capacity (e.g., 30M) or bandwidth requirement (e.g., 10 Mbps). The hybrid service may also be initiated transparently to the user by a policy determined by a wireless service provider in order for the service provider to manage system resources and user satisfaction.

In step 503 and step 505, the first electronic device 400 measures the communication quality for the first network 500 and second network 600 in response to the hybrid service initiation. It may be assumed that the first network 500 is a WLAN, and the second network 600 is a mobile communication network. The first electronic device 400 may include a first communication module (e.g., the WLAN module 413) for using the first network 500 and a second communication module (e.g., the mobile communication module 411) for using the second network 600. The first electronic device 400 may activate both the first communication module and the second communication module in response to the initiation of the hybrid service. For example, the first electronic device may be connected to the first network 500 through the first communication module and to the second network 600 by the second communication module. The first electronic device 400 may further selectively turn on and off the first communication module.

The communication quality measurement may be performed for both the first network 500 and second network 600, or only for the first network 500. For example, when following the assumption on the networks as described above, the first network 500 (e.g., the wireless LAN) has a low communication quality (where it is difficult to guarantee the communication quality) compared to the second network 600 (e.g., the mobile communication network) and the communication quality may not be adjustable while the second network 600 has a high communication quality (where the communication quality is guaranteed) compared to the first network 500, and it is possible to adjust the communication quality. Therefore, when measuring the communication quality, the following operations may be performed by measuring the communication quality of the first network 500 or both the first network 500 and the second network 600.

The communication quality measurements may measure throughput, latency, cell or access point congestion, block error rates and delay, etc. between the first electronic device 400 and corresponding networks. The communication quality actually experienced by the user may be determined by the quality of end-to-end service (e.g., the first electronic device 400 to the second electronic device 700), and the throughput and delay may be measured by exchanging test packets with the other party. The communication quality of the first network 500 may be acquired through the transmission and reception of test packets. The first electronic device 400 may request the first network 500 to measure network quality, receive a result thereof from the first network 500, or check a buffer status of the first network 500 to estimate the communication quality.

In step 507, the first electronic device 400 determines the QoS for data communication based on the result of communication quality measured for the first and second networks. The first electronic device 400 may determine the QoS by considering the communication quality measured for the connected first network 500. The first electronic device 400 may determine the QoS of the second network 600 according to the communication quality of the first network 500. When determining the QoS of the second network 600, the first electronic device 400 may determine the QoS by additionally considering the communication quality measured for the second network 600. The current communication quality of the second network 600 may be lower than the QoS of the second network 600 determined according to the communication quality of the first network 500, so that the QoS may be determined by including the communication quality of both networks.

The first electronic device 400 may have a conversion table correlating the communication quality of the first network 500 and the second network 600. The first electronic device 400 may be connected to the second network 600 to have the communication quality of the first network 500 via the conversion table. The first electronic device 400 may be connected to the second network 600 so that the additional communication required by the first network 500 is supported through the second network 600. The above operations may be performed when the communication quality of the first network 500 drops to a level equal to or less than a Predetermined level.

In step 509 and step 511, the first electronic device 400 reports service information corresponding to the determined QoS to the second network 600 and the second electronic device 700. The service information may indicate the QoS determined by the first electronic device 400 based on the communication quality of the networks. The service information may include information indicating the communication quality of the first network 500 to which the first electronic device 400 is connected. In addition, information indicating the communication quality of the second network 600 may be tabulated and managed as shown in Table 1 below. Information on the communication quality of the first network 500 may be directly inserted and transmitted. For example, the throughput and delay measured by the communication in the first network 500 connected to the first electronic device 400 may be inserted and transmitted.

TABLE 1

| | Bearer | | Packet | Packet | |
|---|---|---|---|---|---|
| QCI | Type | Priority | Delay | Loss | Example |
| 1 | GBR | 2 | 100 ms | 10⁻² | VoIP call |
| 2 | | 4 | 150 ms | 10⁻³ | Video call |
| 3 | | 3 | 50 ms | | Online Gaming |
| | | | | | (Real Time) |
| 4 | | 5 | 300 ms | 10⁻⁶ | Video streaming |
| 5 | Non-GBR | 1 | 100 ms | | IMS Signaling |
| 6 | | 6 | 300 ms | | Video, TCP based |
| | | | | | services e.g. |
| | | | | | email, chat, ftp |
| | | | | | etc |
| 7 | | 7 | 100 ms | 10⁻³ | Voice, Video, |
| | | | | | Interactive gaming |
| 8 | | 8 | 300 ms | 10⁻⁶ | Video, TCP based |
| | | 9 | | | services e.g. |
| | | | | | email, chat, ftp |
| | | | | | etc |

For example, as shown in Table 1, for the second network (e.g., LTE), the QoS has been divided into a default bearer and a dedicated bearer. The dedicated bearer may be further divided into non-guaranteed bit rate (Non-GBR) and guaranteed bit rate (GBR), and the dedicated bearer may belong to the non-GBR. As shown in Table 1, a different QoS class of identifier (QCI) may be assigned for transmitted data or for each signal, and each QCI may have different radio bearer requirements. For example, a VoIP call that may require a packet delay condition of 100 ms and a packet loss requirement of 10⁻².

The service information may be inserted into a header of a particular message (e.g., a session release message (for SIP BYE message)) or a message body and transmitted to the second network 600. Table 2 below illustrates a case where information indicating the communication quality is included in the header portion of the SIP BYE message.

TABLE 2

| | | |
|---|---|---|
| SIP BYE MESSAGE | Quality Information | Content |

The second network 600 receiving a session release message or a signal including service information as in the example of Table 2 may adjust the quality of a session connected to the first electronic device 400 by utilizing information indicating the communication quality of the first network 500 to which the first electronic device 400 is connected, the information having been inserted into the session release message.

The service information may be included in a particular message (e.g., a hybrid service initiation request or a data transmission request message) and transmitted to the second electronic device 700. The hybrid service initiation request message (or data transmission request message) may be transmitted to the second electronic device 700 based on at least a part of the first network 500 or the second network 600.

In step 513, the second electronic device 700 initiates a hybrid service. The second electronic device 700 may recognize the initiation of the hybrid service in response to the reception of a message including the service information from the first electronic device 400.

In step 515, the second electronic device 700 partitions the data to correspond to heterogeneous networks. The second electronic device 700 may separate a data session to correspond to two communication paths of heterogeneous networks such as the first partitioned data and the second partitioned data. The first electronic device 400 and the second electronic device 700 may be connected to each other for data communication based on a hybrid service, and the partitioned data may be transferred through different communication paths. For example, for a video call, a session for video data and a session for audio data may be separately established, each with its own QoS requirements, and the video data and the audio data may be exchanged between electronic devices by utilizing each of the sessions. For a video conference, a session for video data and a session for audio data may be separately established. For a video streaming service, the video data may be transmitted after being divided into separate sessions. A video stream which is encoded by utilizing video coding (e.g., scalable video coding (SVC), etc.) has a session for transmitting video frames in a base layer and a session for transmitting an enhancement layer. The sessions are separately established and the data may be transmitted through the respective sessions. For the video stream, a session for a left image and a session for transmitting the difference between a left image and a right image are separately established, and data may be transmitted through the respective sessions.

In step 517, the second electronic device 700 establishes each communication path to transmit the partitioned data, and in step 519 and step 521, the second electronic device 700 transmits the partitioned data to the first network 500 and second network 600. The second electronic device 700 may set the first partitioned data to the first communication path corresponding to the first network 500 and set the second partitioned data to the second communication path corresponding to the second network 600. The second electronic device 700 may transmit data by utilizing different communication modules (e.g., the first communication module and the second communication module) for each session of the partitioned data. The video call and the video data session of the video conference may transmit data to the second network 600 based on the second communication module, and the audio data session may transmit data to the first network 500 based on the first communication module. A session for transmitting the video base layer may transmit data to the second communication module, and a session for transmitting the enhancement layer may transmit data to the first communication module. On the other hand, the session for the left image of the video stream may transmit data to the second communication module, and the session for transmitting the difference between the left image and the right image may transmit data to the first communication module.

In step 523 and step 525, the first network 500 and second network 600 separately receive the partitioned data (e.g., the first partitioned data and the second partition data) transmitted from the second electronic device 700, and individually transmit the partitioned data to the first electronic device 400. When transferring the partitioned data (e.g., the first partition data) to the first electronic device 400, the second network 600 may transmit the partitioned data based on a connection session newly established to correspond to the service quality measured by the first electronic device 400 rather than a previously-established connection session.

In step 527, the first electronic device 400 processes the partitioned data received from the first network 500 and the second network 600 to output the processed data. The first electronic device 400 may perform data processing such as buffering, decoding, and recovering (e.g., synchronization and combination of the partitioned data) for the partitioned data, in response to the reception of the first partitioned data and the second partitioned data, and process an output (e.g., streaming service, storage, etc.) of completed data.

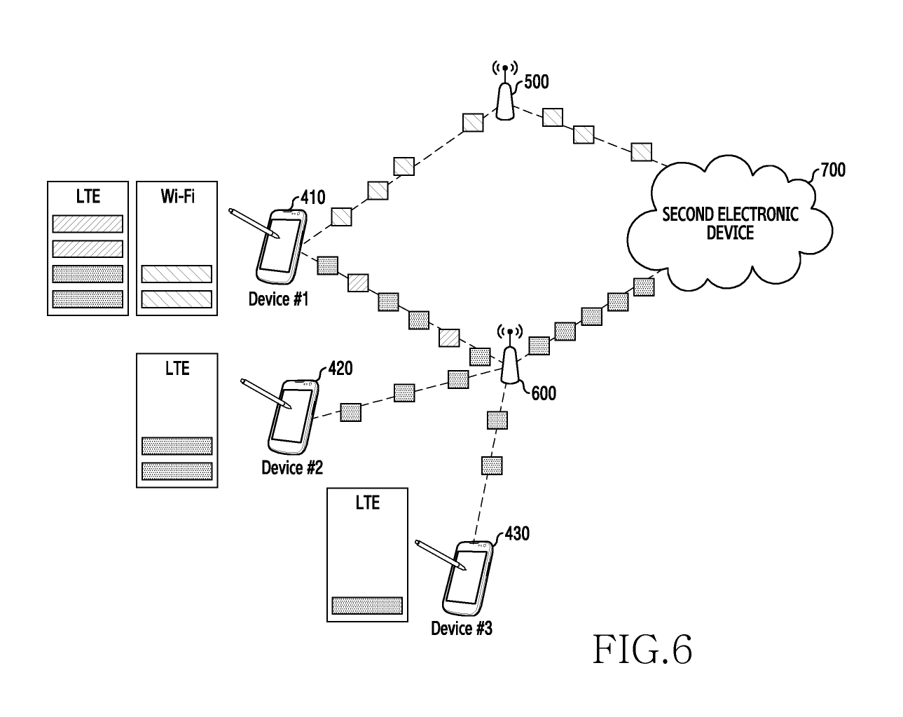

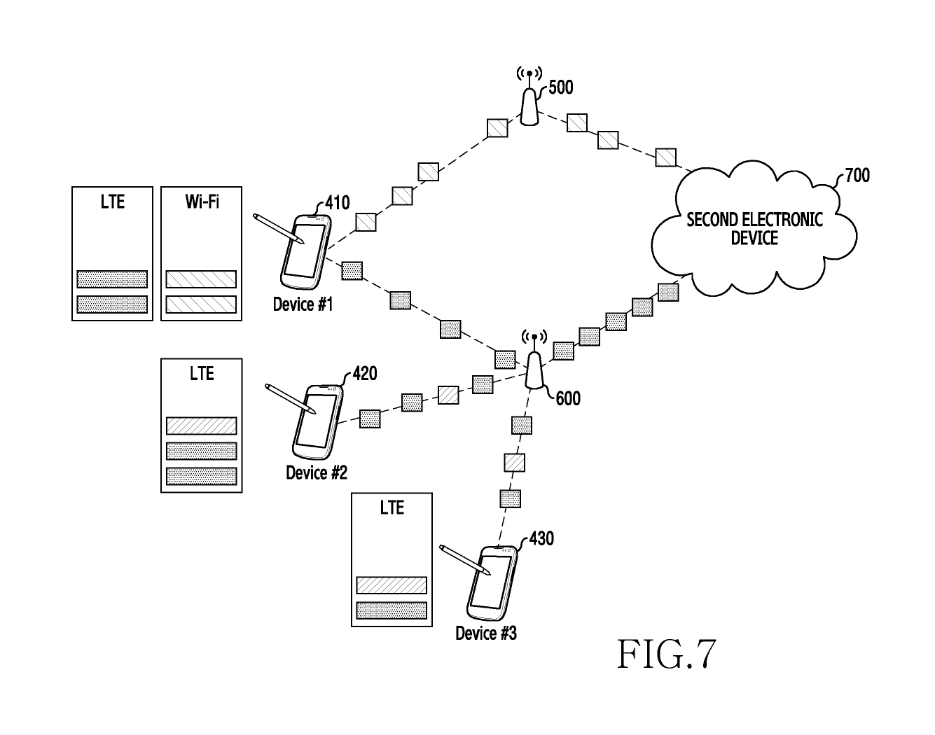

FIGS. 6 and 7 are diagrams illustrating operations supporting data communication of an electronic device according to various embodiments of the present disclosure.

FIGS. 6 and 7 are diagrams illustrating operations when data is separated by the second electronic device 700 and transmitted to the first electronic device 400 through different communication paths (for example, the first network 500 and the second network 600).

When the data is separated and transferred through different communication paths, FIG. 6 may represent each buffer state according to a first communication path and a second communication path of the electronic device. For example, FIG. 6 shows the transmission of data (e.g., video data compressed using a video codec) through a plurality of communication means along with a buffer. In FIG. 6, Device #1 410 may receive data through the second network 600 and the first network 500, and Device #2 420 and Device #3 430 may receive data only through the second network 600.

In FIG. 6, it may be seen that more packets are transmitted through the second network 600 as compared to the first network 500 to Device #1 410 which receives data through different communication paths. This may occur because the communication speed of the second network 600 is higher than the communication speed of the first network 500.

On the other hand, buffers of the Device #2 420 and Device #3 430 may not be filled enough and indicate an empty state. As a result, the Device #2 420 and Device #3 430 may not receive an adequate QoS. For example, users of the Device #2 420 and Device #3 430 may experience a seamless video stream. That is, as shown in FIG. 6, when providing data (e.g., a multimedia streaming service) through the first network 500 and second network 600, the second network 600 may provide a service beyond that which is required as compared to the first network 500, and the service beyond that which is required may be provided only to the Device #1 410.

When providing data through the first network 500 and the second network 600, a service is provided at a level required by an electronic device by adjusting the QoS of the second network 600 which may provide an improved service to other electronic devices by managing network resources.

Referring to FIG. 7, when the data is separated and transferred through different communication paths, FIG. 7 may represent each buffer state according to a first communication path and a second communication path of the electronic device. For example, FIG. 7 shows the transmission of particular data (e.g., video data compressed in a video codec) through a plurality of communication means along with a buffer. In FIG. 7, Device #1 410 may receive data through the second network 600 and the first network 500, and Device #2 420 and Device #3 430 may receive data through the second network 600.

In Device #1 410 which receives data through different communication paths, it may be seen that the first network 500 and the second network 600 substantially transmit the same amount of data as compared to FIG. 6. This may result by adjusting the QoS of the second network 600 by the Device #1 410 based on the QoS determined for the synchronization of the first network 500 and the second network 600 by considering the communication quality of the first network 500 and the second network 600.

Buffers of Device #2 420 and Device #3 430, in FIG. 7 as compared to FIG. 6, may indicate additionally receiving data as network resources are secured according to the adjustment of the QoS for Device #1 410.

Thus, according to various embodiments of the present disclosure, it is possible to determine the QoS required for the communication with the second network 600 by considering the communication quality of the first network 500 connected to the first electronic device 400. The first electronic device 400 may report the determined QoS according to the first network 500 to the second network 600, and the first electronic device 400 and the second network 600 may re-establish a connection session based on the QoS. For example, the QoS of the second network 600 may be determined according to the communication quality of the first network 500.

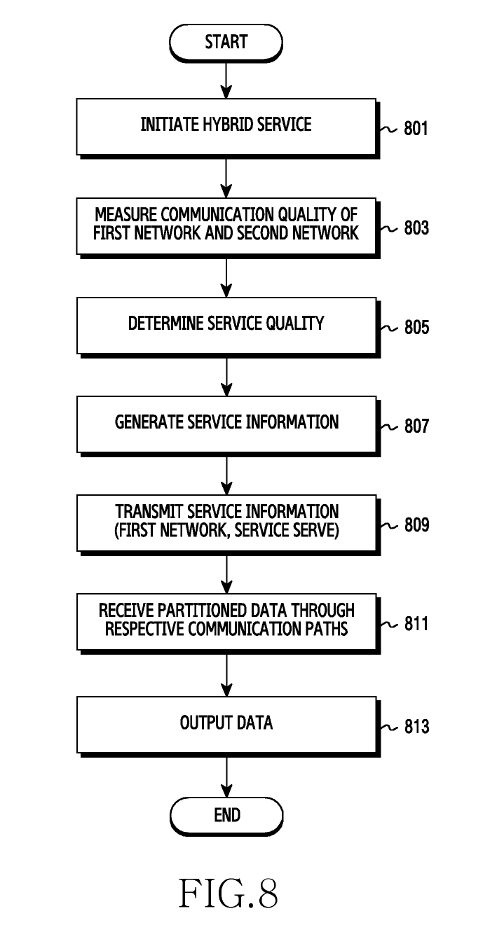

FIG. 8 is a flowchart illustrating an operation of data communication in an electronic device according to various embodiments of the present disclosure.

Referring to FIG. 8, in step 801, the controller 480 initiates a hybrid service. The controller 480 may initiate the hybrid service in response to a user's input, for receiving data, an application or execution of an operator's policy. When initiating the hybrid service, the controller 480 may check the on/off state of the first communication module (e.g., wireless LAN module 413), or whether the first communication module is connected to the first network 500, and when the first communication module is off (or not connected), the controller 480 may turn on the first communication module.

In step 803, the controller 480 measures the communication quality of the first network 500 and second network 600. The communication quality measurement exchanges a test packet between the first electronic device 400 and corresponding networks and measures throughput and delay, etc.

In step 805, the controller 480 determines the QoS for data communication based on communication quality measured for the networks. The controller 480 may determine the QoS to be used in data communication with the second network 600 by considering the communication quality measured for the connected first network 500. That is, the controller 480 may determine the QoS of the second network 600 according to the communication quality of the first network 500. The current communication quality of the second network 600 may be lower than the QoS of the second network 600 according to the communication quality of the first network 500, so that the QoS may be determined by including both the communication quality of the first network 500 and the second network 600. The controller 480 may determine the QoS of the second network 600 to have the communication quality corresponding to the communication quality of the first network 500. The controller 480 may determine the QoS by synchronizing the communication quality of the first network 500 and the communication quality of the second network 600 to have the same communication quality. The controller 480 may determine the QoS of the second network 600 such that the communication additionally required for the communication in the first network 500 is supported through the second network 600.

In step 807, the controller 480 generates service information based on the determined QoS. The service information may include information on the result of the QoS based on the communication quality of the networks. The service information may include throughput and delay information indicating the communication quality of the first network 500 to which the electronic device 400 is connected.

In step 809, the controller 480 transmits service information corresponding to the determined QoS. For example, the controller 480 may report the service information to the second network 600 and the second electronic device 700 (e.g., a server or other electronic device). For example, the controller 480 may transmit, to the second electronic device 700, a data transmission request message including the service information (or a hybrid service initiation request message), and transmit, to the second network 600, a session control message (e.g., a session release message (e.g., SIP BYE message)) including the service information.

In step 811, the controller 480 receives the partitioned data through respective communication paths. For example, the controller 480 may receive the first partitioned data from the first network 500 connected through a first communication module (e.g., a wireless LAN module 413) and receive the second partitioned data from the second network 600 connected through the second communication module (e.g., a mobile communication module 411). In an embodiment of the present disclosure, the partitioned data may be transferred to the electronic device 400 according to the same communication quality based on the synchronization of the communication quality of the first network 500 and the communication quality of the second network 600.

In step 813, the controller 480 processes each piece of partitioned data received from the first network 500 and the second network 600 to output the processed data. For example, the controller 480 may perform data processing, such as, buffering, decoding, and recovering (e.g., synchronization and combination of the partition data) for the first partitioned data received through the first communication module and the second partitioned data received through the second communication module, and process an output of completed data generated as a result thereof.

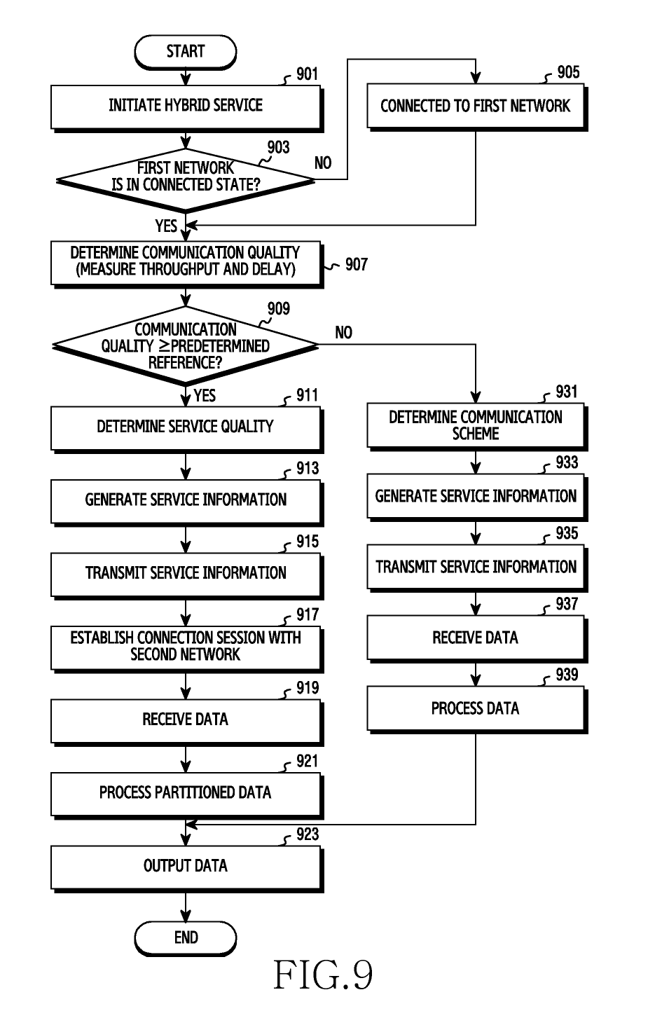

FIG. 9 is a flowchart illustrating an operation of processing data reception in an electronic device according to various embodiments of the present disclosure.

Referring to FIG. 9, in step 901, the controller 480 initiates a hybrid service. For example, the controller 480 may initiate the hybrid service in a case where a user input is intended for the hybrid service, an application associated with the hybrid service is executed, a policy of the user's service provider is executed, or the amount of data requested is greater than or equal to a predetermined capacity.

In step 903, the controller 480 determines a connection state of the first network 500 when initiating the hybrid service. For example, the controller 480 may check an on/off state of the first communication module (e.g., a wireless LAN module 413) or the first communication module is connected to the first network 500.

In step 903, when the controller 480 determines that the first communication module is not connected to the first network 500 (‘No’ in step 903), the controller 480 establishes a connection with the first network 500 in step 905. For example, in a state where the second network 600 is connected by the second communication module (e.g., a mobile communication module 411), the controller 480 may activate the first communication module to be connected to the first network 500.

In step 903, when it is determined that the first network 500 is connected to the first communication module (‘Yes’ in step 903), the controller 480 determines the communication quality, in step 907. For example, the controller 480 may exchange test packets between the networks, and measure throughput and delay, etc. to determine the communication quality.

In step 909, the controller 480 determines whether the communication quality is higher than a predetermined reference. For example, the controller 480 may compare the measured communication quality of the first network 500 to a first predetermined reference, and determine whether the communication quality of the first network 500 is satisfied. In addition, the controller 480 may compare the measured communication quality of the second network 600 to a second predetermined reference, and determine whether the communication quality of the second network 600 is satisfied. In the following description, a case of determining the communication quality of the first network 500 is described as an example, but the present disclosure is not limited thereto, and it should be understood that the present disclosure may consider both the communication quality of the first network 500 and the communication quality of the second network 600.

In step 909, when it is determined that the communication quality is equal to or higher than a predetermined reference (‘Yes’ in step 909), the controller 480 determines the QoS in step 911. For example, the controller 480 may determine the QoS (QoS) to be used in data communication with the second network 600 by considering the communication quality of the first network 500. That is, the controller 480 may determine the resource allocation required for the service on the second network 600 according to the communication quality of the first network 500. The controller 480 may determine the QoS so that the second network 600 supports communication on the basis of the communication quality of the first network 500.

In step 913, the controller 480 generates service information based on the determined QoS. The service information may include information on the QoS for the second network 600 determined by the controller 480 based on communication quality of the first network 500 (e.g., information indicating the communication quality of the first network 500 such as throughput and delay information).

In step 915, the controller 480 transmits service information corresponding to the determined QoS. For example, the controller 480 may report the service information to the second network 600 and the second electronic device 700 (e.g., a server or other electronic devices). For example, the controller 480 may transmit, to the second electronic device 700, a data transmission request message including the service information (or a hybrid service initiation request message), and transmit, to the second network 600, a session control message (e.g., a session release message (e.g., SIP BYE message)) including the service information.

In step 917, the controller 480 establishes a connection session with the second network 600. The controller 480 may re-establish a connection session with the second network 600 in response to the transmission of the session control message including the service information to the second network 600. A protocol such as a session initiation protocol (SIP) may be used in newly establishing a connection session with the electronic device 400 and the second network 600. The SIP message may be a SIP message start line, a SIP header, and a SIP message body. The controller 480 may set a new connection session by using the SIP INVITE message, and an existing connection session overlapped with the second network 600 may be released. Here, the connection session release message (e.g., SIP BYE message) for releasing the connection session, or a signal may be transmitted. The service information indicating the communication quality of the first network 500 connected through the first communication module may be inserted into the session connection release message or the signal and then be transmitted. In the second network 600, information indicating the communication quality such as in Table 1 above is managed in a tabular form. The second network 600 may determine the QoS corresponding thereto based on the service information received from the electronic device 400, and re-establish a connection session with the first electronic device 400 based on the determined QoS. The second network 600 may adjust the communication quality of the connection session required for the connection with the first electronic device 400 by utilizing the information indicating the communication quality of the first network 500 inserted into the connection session release message.

In step 919, the controller 480 receives data. The controller 480 may receive partitioned data corresponding to the data received through respective communication paths. The controller 480 may receive the first partitioned data from the first network 500 connected through a first communication module (e.g., a wireless LAN module 413) and receive the second partitioned data from the second network 600 connected through the second communication module (e.g., a mobile communication module 411). The partitioned data may be transferred to the first electronic device 400 according to the same communication quality based on the synchronization of the communication quality of the first network 500 and the communication quality of the second network 600.

In step 921 and step 923, the controller 480 processes the partitioned data. For example, the controller 480 may process the partitioned data received from the first network 500 and the second network 600. The controller 480 may perform data processing such as buffering, decoding, and recovering (e.g., synchronization and combination of the partitioned data) for the first partitioned data received through the first communication module and the second partitioned data received through the second communication module, and process an output of complete data.

In step 909, when it is determined that the communication quality is lower than a predetermined threshold (‘No’ in step 909), the controller 480 determines a communication scheme for receiving data in step 931. For example, the controller 480 may switch the hybrid service to an inactive state and receive the data based on the second network 600. The controller 480 may receive data based on the hybrid service according to the change of the communication quality in the first network 500 while maintaining the hybrid service in an active state and receiving data based on the second network 600. The determination of the communication scheme may operate based on configuration information, service provider policy, or a user input previously configured in the electronic device 400.

In step 933, the controller 480 generates service information based on the determined communication scheme. The service information may include information on the QoS for the second network 600 determined by the controller 480 based on communication quality of the first network 500 (e.g., information indicating the communication quality of the first network 500). The service information may include information indicative of the data communication performed by the second network 600 without the data communication by the first network 500.

In step 935, the controller 480 transmits the service information. For example, the controller 480 may report the service information to the second electronic device 700 (e.g., a server or other electronic devices). The controller 480 may transmit a data transmission request message including the service information (e.g., data transmission information according to the second network 600) to the second electronic device 700.

In step 937, the controller 480 receives data. For example, the controller 480 may receive data from the second network 600 connected through the second communication module.

In step 939 and step 923, the controller 480 processes the received. For example, the controller 480 may perform buffering, decoding, combining, etc. for data received through the second communication module and output the data.

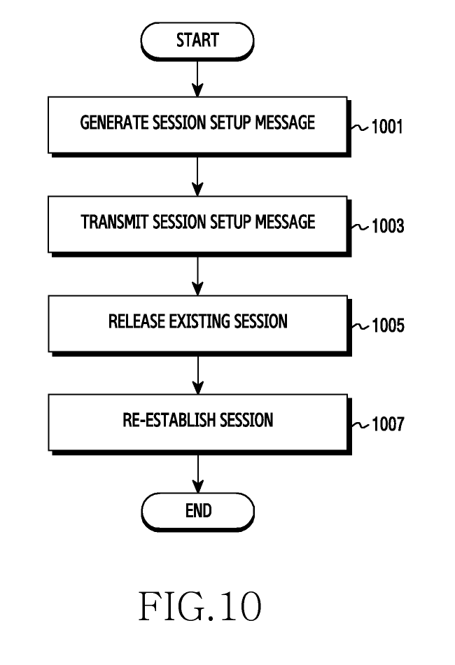

FIG. 10 is a flowchart illustrating an operation of re-establishing network connection in an electronic device according to various embodiments of the present disclosure.

Referring to FIG. 10, in step 1001, the controller 480 generates a session setup message including service information. For example, a session initiation protocol (SIP) message may be used in a process of newly establishing a session between the electronic device 400 and the second network 600. An embodiment of the present disclosure may re-establish a new session for system resource management while releasing the existing session by using a SIP message including the service information.

In step 1003, the controller 480 transmits a session setup message. For example, the controller 480 may transmit, to the second network 600, the session setup message including the service information. The second network 600 may notify of a release of the existing connection session with the first electronic device 400 to the electronic device 400 in response to the reception of the session setup message, and re-establish a session with the first electronic device 400 based on the service information of the session setup message. The second network 600 may determine the QoS corresponding to the service information in Table 1, determine a resource to be assigned to the first electronic device 400 on the basis of the determined QoS, and perform a session control process corresponding to the determined resource. That is, the second network 600 may adjust the quality of the communication with the first electronic device 400 based on the service information.

In step 1005, the controller 480 releases the existing connection session with the second network 600 in response to a notification of the second network 600.

In step 1007, the controller 480 re-establishes the session to correspond to the QoS based on the second network 600 and the service information.

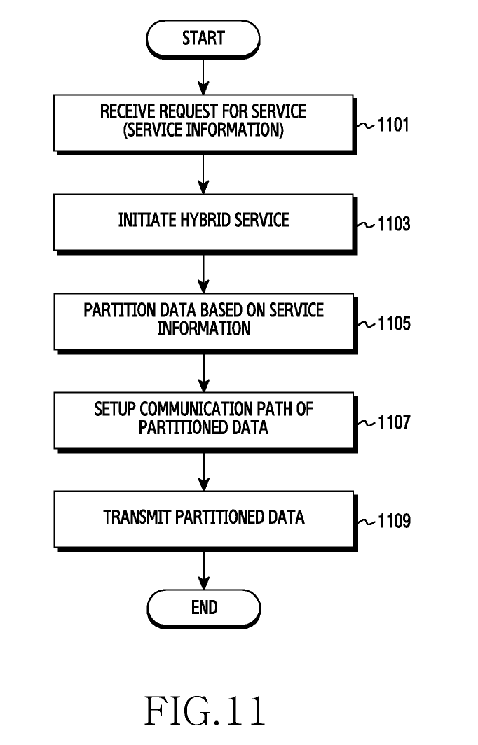

FIG. 11 is a flowchart illustrating an operation of data transmission in an electronic device according to various embodiments of the present disclosure.

Referring to FIG. 11, in step 1101, the controller 480 receives a request for a service. For example, the controller 480 may receive a data transmission request message including service information from the electronic device which requests data transmission.

In step 1103, the controller 480 initiates a hybrid service in response to the reception of the data transmission request message. For example, when receiving the data transmission request message, the controller 480 may determine whether or not to include the service information. When the service information is included in the data transmission request message, the controller 480 may determine an initiation of the hybrid service, and when the service information is not included in the data transmission request message, the controller 480 may determine general (non-hybrid) initiation of the data transmission.

In step 1105, the controller 480 partitions data based on the service information. The controller 480 may determine the hybrid data transmission by the first network 500 and the second network 600, and separate the data into first partitioned data and second partitioned data in response to the determination.

In various embodiments of the present disclosure, the data may be partitioned by various methods. The controller 480 may partition the data by using a technique of multiple description coding (MDC). For example, it is possible to divide a video frame of data into an even frame and an odd frame to perform coding, or base layer frames and enhancement layer frames. The controller 480 may have data coded by using this method. The data coded in this form may be transmitted to the electronic device through a plurality of communication means. For example, a first description of the MDC may be transmitted through a first network (e.g., a WLAN), and a second description of the MDC may be transmitted through the second network (e.g., a mobile communication network).

According to an embodiment of the present disclosure, the controller 480 may partition data based on a tile structure of H.265. For example, one video frame of data may be divided into several tiles, and each tile may be configured to a plurality of independently parsable blocks. The data may be coded for each block or for each tile, and the coded data may be transmitted to the electronic device through a plurality of communication means.

In step 1107, the controller 480 sets the communication path of the partitioned data. For example, the controller 480 may set a communication path for transmitting the first partitioned data through the first network 500 and a communication path for transmitting the second partitioned data through the second network 600. The first partitioned data and second partitioned data are different data separated by the data session, as previously discussed, or may be the same data.

In step 1109, the controller 480 transmits the partitioned data. For example, the controller 480 may transmit the first partitioned data and the second partitioned data to the first network 500 and the second network 600 through the set communication paths. The electronic device which receives the partitioned data through the first network 500 and second network 600 may decode the partitioned data and provide the decoded data to the user.

According to various embodiments of the present disclosure, an electronic device and an operation method thereof are provided. The electronic device for receiving data through heterogeneous networks may provide information related to the QoS of the heterogeneous networks, thereby supporting data transmission by the synchronization of the service quality of the heterogeneous networks.

According to various embodiments of the present disclosure, more efficient system resource allocation for data transferred through heterogeneous networks based on the information related to the QoS is provided. Various embodiments of the present disclosure allow more efficient use of the radio resources when transferring data through heterogeneous networks, thereby increasing the resource efficiency of the overall communication system.

According to various embodiments of the present disclosure, an optimal environment for data communication between electronic devices is provided and thus user convenience and usability, convenience, accessibility, and competitiveness of the electronic device may be improved.

Embodiments of the present disclosure disclosed herein and shown in the drawings are examples presented in order to describe technical details of the present disclosure and to help the understanding of the present disclosure, and do not limit the scope of the present disclosure. Therefore, it should be construed that, in addition to the embodiments disclosed herein, all modifications and changes, or modified and changed forms derived from the technical idea of the present disclosure fall within the scope of the present disclosure as defined in the appended claims and their equivalents.

What is claimed is:

1. An electronic device comprising:
a first communication module configured to perform communication with a first network;
a second communication module configured to perform communication with a second network; and
a controller connected to the first communication module and the second communication module, wherein the controller is configured to:
measure communication quality of a network in response to an initiation of a hybrid service, determine the quality of service (QoS) for data communication on the basis of the measured communication quality, provide information on the determined QoS, and process the reception of data transmitted through different communication paths corresponding to the QoS.

2. The electronic device of claim 1, wherein the controller is further configured to establish a connection to the first network in response to the initiation of the hybrid service when the second network is connected.

3. The electronic device of claim 1, wherein the controller is further configured to measure a communication quality of the first network, and determine the QoS to be used in data communication with the second network by considering the communication quality of the first network.

4. The electronic device of claim 1, wherein the controller is further configured to measure both the communication quality of the first network and the communication quality of the second network, and determine the QoS to be used in data communication with the second network by considering both the communication quality of the first network and the communication quality of the second communication network.

5. The electronic device of claim 1, wherein the controller is further configured to determine the QoS such that the second network has a communication quality corresponding to a communication quality of the first network.

6. The electronic device of claim 1, wherein the controller is further configured to generate service information on the basis of the determined QoS, and transmit a message including the service information to another electronic device.

7. The electronic device of claim 1, wherein the controller is further configured to transmit a message including the service information to the second network, and re-establish a connection session with the second network on the basis of the service information.

8. The electronic device of claim 1, wherein the controller is further configured to receive, through the first communication module connected to the first network and the second communication module connected to the second network, first partitioned data and second partitioned data, wherein the transmitted data is separated into the first partitioned data and the second partitioned data.

9. The electronic device of claim 8, wherein the first partitioned data and the second partitioned data are transmitted according to the same communication quality on the basis of synchronization of the communication quality of the first network and the communication quality of the second network.

10. A method for operating an electronic device, comprising:
initiating a hybrid service;
measuring communication quality of a network to which the electronic device is connected;
determining a quality of service (QoS) for data communication on the basis of the measured communication quality;
transmitting service information on the determined QoS; and
receiving data transmitted through different communication paths corresponding to the QoS.

11. The method of claim 10, further comprising:
establishing a connection to a first network in response to the initiation of the hybrid service when a second network is connected.

12. The method of claim 11, wherein measuring the communication quality of the network comprises:
measuring the communication quality of the first network.

13. The method of claim 12, wherein determining the QoS comprises:
determining the QoS to be used in the data communication with the second network by considering the communication quality of the first network.

14. The method of claim 11, wherein measuring the communication quality of the network comprises:
measuring the communication quality of the first network and the communication quality of the second network.

15. The method of claim 14, wherein determining the QoS comprises:
determining the QoS to be used in the data communication with the second network by considering the communication quality of the first network and the communication quality of the second network.

16. The method of claim 11, wherein determining the QoS comprises:
determining the QoS such that the second network has communication quality corresponding to a communication quality of the first network.

17. The method of claim 11, wherein transmitting the service information comprises:
generating service information on the basis of the determined QoS; and
transmitting a message including the service information to another electronic device.

18. The method of claim 11, further comprising:
transmitting a message including the service information to the second network; and
re-establishing a connection session with the second network on the basis of the service information.

19. The method of claim 11, wherein receiving the data comprises:
receiving, through the first network and the second network, first partitioned data and second partitioned data, wherein the transmitted data is separated into the first partitioned data and the second partitioned data, and, wherein the first partitioned data and the second partitioned data are received according to a same communication quality on the basis of synchronization of the communication quality of the first network and the communication quality of the second network.

20. A non-transitory computer readable recording medium in which a program for executing operations is recorded thereon, the operations comprising:
initiating a hybrid service;
measuring communication quality of a network to which an electronic device is connected;
determining a quality of service (QoS) for data communication on the basis of the measured communication quality;
transmitting information on the determined QoS; and
receiving data transmitted through different communication paths corresponding to the QoS.
